(19) United States
(12) Patent Application Publication
(10) Pub. No.: US 2025/0103699 A1
(43) Pub. Date: Mar. 27, 2025

(54) MANAGEMENT APPARATUS, GENERATION APPARATUS, TERMINAL APPARATUS, INFORMATION PROCESSING APPARATUS, MANAGEMENT METHOD, GENERATION METHOD, INFORMATION PROCESSING METHOD, AND PROGRAM

(71) Applicant: NEC Corporation, Minato-ku, Tokyo (JP)

(72) Inventor: Tomoki INOUE, Tokyo (JP)

(73) Assignee: NEC Corporation, Minato-ku, Tokyo (JP)

(21) Appl. No.: 18/554,729

(22) PCT Filed: Jun. 7, 2023
(86) PCT No.: PCT/JP2023/021160

§ 371 Date: Oct. 10, 2023

(51) Int. Cl. G06F 21/44

(52) U.S. Cl. CPC G06F 21/44

(57) ABSTRACT

A management apparatus includes: an obtaining means that obtains an existence confirmation result, which is a result of confirmation on existence of a subject; and a management means that manages the existence confirmation result in association with a non-fungible token.

### TECHNICAL FIELD

The present invention relates to a management apparatus, a generation apparatus, a terminal apparatus, an information processing apparatus, a management method, a generation method, an information processing method, and a program.

### BACKGROUND ART

There have been known biometric authentication techniques, such as fingerprint authentication, iris authentication, and face authentication, according to which a user is authenticated with use of human biological information (for example, Patent Literature 1). These techniques use biological information of an individual, and therefore are more excellent in authentication performance than authentication using a password. Further, these techniques allow a user to utilize a plurality of services with use of biological information registered once. Therefore, these techniques are considered to be more convenient than authentication using a password.

### CITATION LIST

### Patent Literature

[Patent Literature 1]
Published Japanese Translation of PCT International Application, Tokuhyo, No. 2022-544411

### SUMMARY OF INVENTION

### Technical Problem

Desirably, user's biological information and user's personal information associated with the biological information are managed by the user himself/herself. However, in a case of a service involving use of a platform provided by a specific company, such as the one disclosed in Patent Literature 1, the specific company grasps user's biological information and/or personal information, and there is no way to know how these pieces of information are used, disadvantageously.

An example aspect of the present invention was made in consideration of the above problem. An example object of the present invention is to provide an authentication system which is fair and has high transparency.

### Solution to Problem

A management apparatus in accordance with an example aspect of the present disclosure includes: an obtaining means that obtains an existence confirmation result, which is a result of confirmation on existence of a subject; and a management means that manages the existence confirmation result in association with a non-fungible token.

An information processing apparatus in accordance with an example aspect of the present disclosure includes: an obtaining means that obtains specifying information which is for specifying a non-fungible token associated with an existence confirmation result, which is a result of confirmation on existence of a subject; and an authentication means that executes an authentication process which refers to at least either of the existence confirmation result and the non-fungible token.

A management method in accordance with an example aspect of the present disclosure includes: obtaining an existence confirmation result, which is a result of confirmation on existence of a subject; and managing the existence confirmation result in association with a non-fungible token.

A program in accordance with an example aspect of the present disclosure is a program for causing a computer to function as a management apparatus, the program causing the computer to execute: obtaining an existence confirmation result, which is a result of confirmation on existence of a subject; and managing the existence confirmation result in association with a non-fungible token.

### Advantageous Effects of Invention

In accordance with an example aspect of the present invention, it is possible to provide an authentication system which is fair and has high transparency.

### BRIEF DESCRIPTION OF DRAWINGS

FIG. 1 is a block diagram illustrating a configuration of an authentication system in accordance with a first example embodiment.

FIG. 2 is a view illustrating an example of a non-fungible token in accordance with the first example embodiment.

FIG. 3 is a flowchart illustrating a flow of an information processing method in accordance with the first example embodiment.

FIG. 4 is a flowchart illustrating a flow of the information processing method in accordance with the first example embodiment.

FIG. 5 is a flowchart illustrating a flow of the information processing method in accordance with the first example embodiment.

FIG. 6 is a block diagram illustrating a configuration of a generation apparatus in accordance with a second example embodiment.

FIG. 7 is a view illustrating an example of data which is to be processed by the generation apparatus in accordance with the second example embodiment.

FIG. 8 is a block diagram illustrating a configuration of a terminal apparatus in accordance with the second example embodiment.

FIG. 9 is a view illustrating an existence confirmation test to be executed by the terminal apparatus in accordance with the second example embodiment.

FIG. 10 is a block diagram illustrating a configuration of a management apparatus in accordance with the second example embodiment.

FIG. 11 is a view illustrating an example of a configuration of non-fungible data in accordance with the second example embodiment.

FIG. 12 is a view illustrating an example of a configuration of the non-fungible data in accordance with the second example embodiment.

FIG. 13 is a view illustrating a distributed ledger system in accordance with the second example embodiment.

FIG. 14 is a block diagram illustrating a configuration of an information processing apparatus in accordance with the second example embodiment.

FIG. 15 is a view illustrating a display example of display data in accordance with the second example embodiment.

FIG. 16 is a block diagram illustrating a configuration of an information processing apparatus in accordance with the second example embodiment.

FIG. 17 is a block diagram illustrating a configuration of a computer functioning as each apparatus in accordance with each of the example embodiments.

### DESCRIPTION OF EMBODIMENTS

### First Example Embodiment

The following description will discuss a first example embodiment of the present invention in detail with reference to the drawings. The present example embodiment is a basic form of an example embodiment described later.

### <Overview of Authentication System 1>

An authentication system 1 in accordance with the present example embodiment is a system that registers a result of confirmation on existence of a user (user's existence confirmation result) as non-fungible data (NFD) and uses the non-fungible data for authentication of the user. Here, the expression “non-fungible data” means that non-fungible data of a certain user cannot be substituted by data of another user. Note that the expression “non-fungible data” does not exclude updating non-fungible data of a certain user with data of the certain user.

Registration of the non-fungible data is carried out with use of a decentralized distributed ledger system, for example, so as not to depend on a specific company. Further, the authentication system 1 in accordance with the present example embodiment uses, as a distributed ledger system such as the above-described one, a system that has high tampering resistance and that allows data to be browsed from outside. Thus, it is possible to provide an authentication system which is fair and has high transparency.

The user's existence confirmation result in accordance with the present example embodiment includes, for example, a result of biometric authentication on a user. Further, the biometric authentication result in accordance with the present example embodiment can include, for example, data indicating a result of authentication carried out with use of at least any one of various techniques such as the following:
face authentication;
iris authentication;
fingerprint authentication;
vein authentication; and
voice and/or speech authentication.
   Note that the above-described specific examples of the existence confirmation result are in no way intended to limit the present example embodiment. The data of the existence confirmation result may be any data, provided that the data indicates a result of confirmation on existence of the user.

### <Configuration of Authentication System 1>

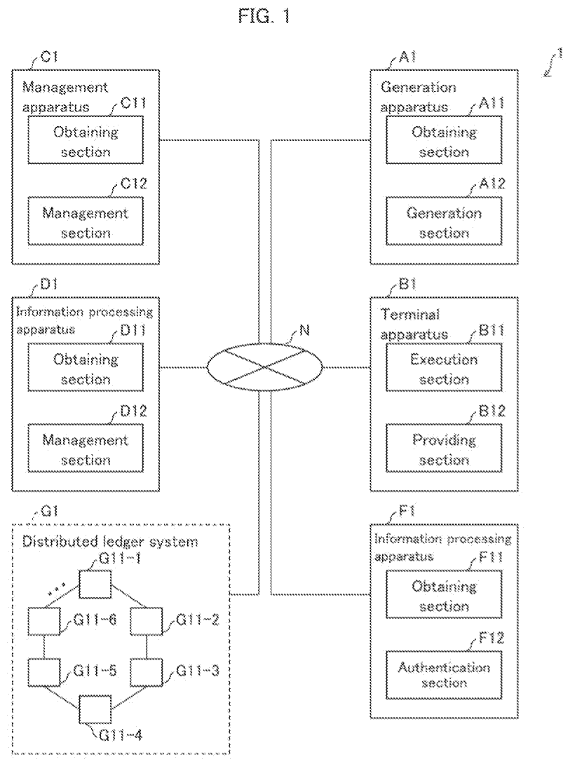

The following will describe, with reference to FIG. 1, a configuration of the authentication system 1. FIG. 1 is a block diagram illustrating a configuration of the authentication system 1 in accordance with the present example embodiment. As shown in FIG. 1, the authentication system 1 includes a generation apparatus A1, a terminal apparatus B1, a management apparatus C1, an information processing apparatus D1, an information processing apparatus F1, and a distributed ledger system G1. Note that it is not essential that the authentication system 1 in accordance with the present example embodiment include all of the apparatuses and systems. A system including only part of these apparatuses and systems can also be an example of the authentication system 1 in accordance with the present example embodiment.

The following will describe an overview of the generation apparatus A1, the terminal apparatus B1, the management apparatus C1, the information processing apparatus D1, the information processing apparatus F1, and the distributed ledger system G1 included in the authentication system 1. Note that each apparatus does not essentially require the whole of its corresponding process described below. Each apparatus may be configured to execute only part of its corresponding process described below.

### (Overview of Generation Apparatus A1)

In cooperation with the terminal apparatus B1, the generation apparatus A1 executes an existence confirmation test and generates an existence confirmation result.

In cooperation with the management apparatus C1, the generation apparatus A1 gives an authentication mark to non-fungible data or updates the non-fungible data.

### (Overview of Terminal Apparatus B1)

The terminal apparatus B1 executes an application for confirmation on existence, and executes the existence confirmation test at a timing when the management apparatus C1 issues (mints) the non-fungible data and at another arbitrary timing.

The terminal apparatus B1 obtains response information indicating a response given by a user in response to the existence confirmation test.

The terminal apparatus B1 executes a process associated with the non-fungible data managed by the information processing apparatus D1.

The terminal apparatus B1 executes, as the existence confirmation test, a test having redundancy (a test including a plurality of authentication tests).

### (Overview of Management Apparatus C1)

In cooperation with the generation apparatus A1 and the terminal apparatus B1, the management apparatus C1 issues (mints) the non-fungible data and updates the existence confirmation result included in the non-fungible data.

The management apparatus C1 registers the non-fungible data in the distributed ledger system G1.

### (Overview of Information Processing Apparatus D1)

The information processing apparatus D1 obtains specifying information which is for specifying the non-fungible data, and manages the non-fungible data.

The information processing apparatus D1 accesses the information processing apparatus F1 with use of the specifying information, and receives a service from the information processing apparatus F1.

### (Overview of Information Processing Apparatus F1)

The information processing apparatus F1 executes an authentication process which refers to the non-fungible data, and provides, in accordance with a result of the authentication, the service to the information processing apparatus D1 that manages the non-fungible data.

### (Configuration of Generation Apparatus A1)

Next, the following will describe a configuration of the generation apparatus A1 with reference to FIG. 1. As shown in FIG. 1, the generation apparatus A1 includes an obtaining section A11 and a generation section A12.

### (Obtaining Section A11)

The obtaining section A11 obtains the reference information which is for confirmation on existence of the subject (subject user). In an example, the obtaining section A11 obtains, from the terminal apparatus B1 that carries out the existence confirmation test on the subject, the reference information as the response information given by the subject in response to the existence confirmation test.

### (Generation Section A12)

The generation section A12 generates, with reference to the reference information, the existence confirmation result, which is a result of confirmation on existence of the subject and which is to be associated with the non-fungible token (NFT). For example, the existence confirmation result generated by the generation section A12 is supplied to the management apparatus C1 that manages the existence confirmation result in association with the non-fungible token.

As described above, the generation apparatus A1 obtains the reference information which is for confirmation on existence of the subject, and generates the existence confirmation result of the subject with reference to the reference information. Here, the existence confirmation result generated by the generation apparatus A1 is information which is associated with the non-fungible token and is managed in a non-fungible manner. Therefore, with the above configuration, it is possible to provide an authentication system which is fair and has high transparency.

### (Configuration of Terminal Apparatus B1)

Next, the following will describe a configuration of the terminal apparatus B1 with reference to FIG. 1. As shown in FIG. 1, the terminal apparatus B1 includes an execution section B11 and a providing section B12. In an example, the terminal apparatus B1 is a terminal that is operated by the subject (user). This, however, is in no way intended to limit the present example embodiment.

### (Execution Section B11)

The execution section B11 executes the confirmation test (existence confirmation test) for confirmation on existence of the subject. For example, the execution section B11 executes a confirmation test including a test regarding authentication of a living body.

### (Providing Section B12)

The providing section B12 provides the response information given by the subject in response to the confirmation test to the generation apparatus A1 that generates the existence confirmation result, which is the result of confirmation on existence of the subject and which is to be associated with the non-fungible token.

As described above, the terminal apparatus B1 executes the existence confirmation test which is for confirmation on existence of the subject, and provides, to the generation apparatus A1, the response information given by the subject in response to the existence confirmation test. Further, the response information is referred to by the generation apparatus A1 for generation of the existence confirmation result. Here, the existence confirmation result generated by the generation apparatus A1 is information which is associated with the non-fungible token and is managed in a non-fungible manner. Therefore, with the above configuration, it is possible to provide an authentication system which is: fair and has high transparency.

### (Management Apparatus C1)

Next, the following will describe a configuration of the management apparatus C1 with reference to FIG. 1. As shown in FIG. 1, the management apparatus C1 includes an obtaining section C11 and a management section C12.

### (Obtaining Section C11)

The obtaining section C11 obtains the existence confirmation result, which is the result of confirmation on existence of the subject. For example, the obtaining section C11 obtains the existence confirmation result generated by the generation apparatus A1.

### (Management Section C12)

The management section C12 manages the existence confirmation result in association with the non-fungible token. Here, a specific management method carried out by the management section C12 is in no way intended to limit the present example embodiment. In an example, the management carried out by the management section C12 includes a process of registering, in the distributed ledger system G1, the following:
the non-fungible data including the existence confirmation result and the non-fungible token; or
the non-fungible data which is the non-fungible token including the existence confirmation result.

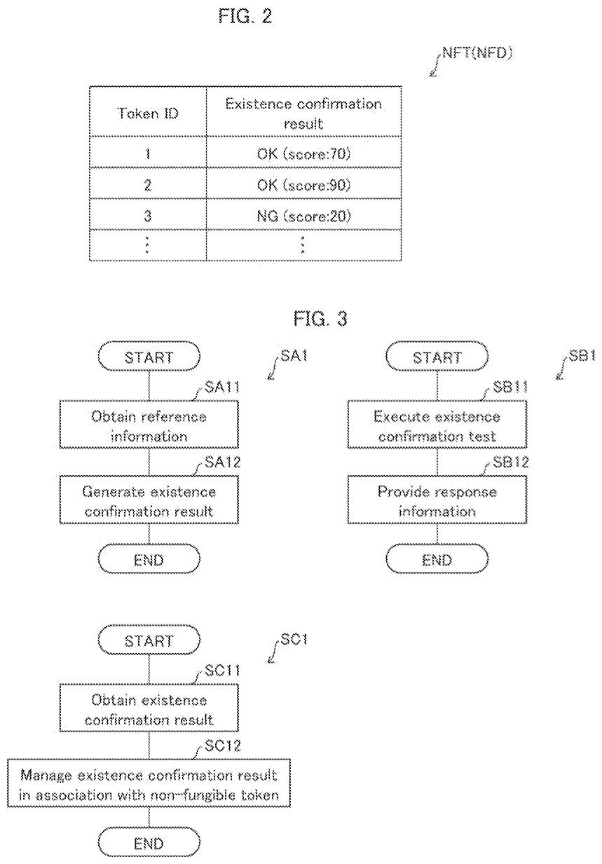

FIG. 2 is a view illustrating an example of a data structure of the non-fungible data NFD, which is to be managed by the management section C12. As shown in FIG. 2, the non-fungible data NFD includes a token ID designating the non-fungible token NFT and the existence confirmation result associated with the token ID. Here, in the example shown in FIG. 2, the following understanding is possible:
The non-fungible data NFD includes the non-fungible token NFT designated by the token ID and the existence confirmation result associated with the token ID; or
The non-fungible token NFT designated by the token ID includes the existence confirmation result associated with the token ID, and the non-fungible token NFT constitutes the non-fungible data NFD.
   Thus, the non-fungible data NFD shown in FIG. 2 can be expressed as including:
information indicating the existence confirmation result, which is the result of confirmation on existence of the subject; and
the non-fungible token associated with information indicating the existence confirmation result.

Further, as shown in FIG. 2, the existence confirmation result included in the non-fungible data NFD includes, for example, information indicating whether or not the subject has successfully passed the existence confirmation test (whether or not the existence confirmation test was succeeded) (OK or NG in FIG. 2) and a score of the existence confirmation test. Note, however, that this configuration is in no way intended to limit the present example embodiment.

As described above, the management apparatus C1 obtains the existence confirmation result, which is the result of confirmation on existence of the user, and manages the existence confirmation result in association with the non-fungible token. Therefore, with the above configuration, it is possible to provide an authentication system which is fair and has high transparency.

### (Information Processing Apparatus D1)

Next, the following will describe a configuration of the information processing apparatus D1 with reference to FIG. 1. As shown in FIG. 1, the information processing apparatus D1 includes an obtaining section D11 and a management section D12. In an example, the information processing apparatus D1 is an apparatus that is operated by the subject (user). This, however, is in no way intended to limit the present example embodiment.

### (Obtaining Section D11)

The obtaining section D11 obtains the specifying information which is for specifying the non-fungible data including (i) the information indicating the existence confirmation result, which is the result of confirmation on existence of the subject, and (ii) the non-fungible token associated with the information indicating the existence confirmation result. In an example, the obtaining section D11 obtains, as the specifying information which is for specifying the non-fungible data, the token ID, which is an ID of the non-fungible token.

### (Management Section D12)

The management section D12 manages the non-fungible data. Examples of a specific process to be carried out by the management section D12 include:
managing the token ID and a secret key; and
transmitting the token ID of the non-fungible token, the non-fungible data NFD, and/or the like to an external apparatus, using encryption involving use of the secret key.
   However, the present example embodiment is not limited to them. Note that each process carried out by the management section D12 can be understood as including a process to be carried out by a so-called wallet. This, however, is in no way intended to limit the present example embodiment.

As described above, the information processing apparatus D1 obtains the specifying information which is for specifying the non-fungible data including (i) the information indicating the existence confirmation result, which is the result of confirmation on existence of the subject, and (ii) the non-fungible token associated with the information indicating the existence confirmation result, and manages the non-fungible data. Therefore, with the above configuration, it is possible to provide an authentication system which is fair and has high transparency.

### (Information Processing Apparatus F1)

Next, the following will describe a configuration of the information processing apparatus F1 with reference to FIG. 1. As shown in FIG. 1, the information processing apparatus F1 includes an obtaining section F11 and an authentication section F12.

### (Obtaining Section F11)

The obtaining section F11 obtains the specifying information which is for specifying the non-fungible token associated with the existence confirmation result, which is the result of confirmation on existence of the subject.

### (Authentication Section F12)

The authentication section F12 executes an authentication process which refers to at least either of the existence confirmation result and the non-fungible token.

In an example, the information processing apparatus F1 selects, in accordance with a result of authentication carried out by the authentication section F12, a service for the subject, and provides the service thus selected. Here, specific examples of the service to be provided by the information processing apparatus F1 include services such as a game, a financial service, business support, information delivery, and a personnel service. However, they are in no way intended to limit the present example embodiment. In accordance with the result of the authentication carried out by the authentication section F12, the information processing apparatus F1 provides data and/or the like relating to any of these services to a terminal (the terminal apparatus B1, the information processing apparatus D1, or the like) possessed by the user.

As described above, the information processing apparatus F1 obtains the specifying information which is for specifying the non-fungible token associated with the existence confirmation result, which is the result of confirmation on existence of the subject, and executes the authentication process which refers to at least either of the existence confirmation result and the non-fungible token. Therefore, with the above configuration, it is possible to provide an authentication system which is fair and has high transparency.

### (Distributed Ledger System G1)

Next, the following will describe, with reference to FIG. 1, a configuration of the distributed ledger system G1. As shown in FIG. 1, the distributed ledger system G1 includes a plurality of nodes G11-1, G11-2, . . . .

Here, each of the nodes G11-1, G11-2, . . . , stores therein a block chain, which is one example of a distributed ledger. Further, at least any one of the blocks in the block chain has, as transaction data, non-fungible data NFD managed by the above-described management apparatus C1 or the like. The block chain uses a system that has high tampering resistance and that allows data to be browed from outside. Thus, use of the distributed ledger system G1 makes it possible to provide the authentication system 1 which is fair and has high transparency.

### (Flow of Process of Apparatuses in Authentication System 1)

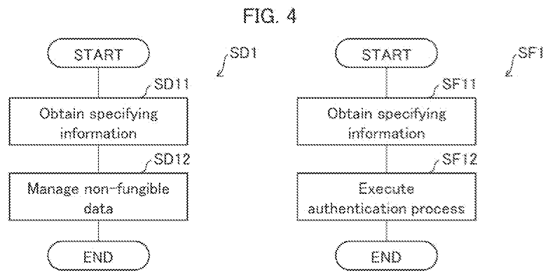

Next, the following will describe, with reference to FIGS. 3 and 4, flows of processes carried out by the apparatuses included in the authentication system 1.

### (Flow of Process of Generation Apparatus A1)

SA1 in FIG. 3 is a flowchart illustrating a flow of a process carried out by the generation apparatus A1. As shown in FIG. 3, the generation apparatus A1 obtains the existence confirmation result, which is the result of confirmation on existence of the subject (step SA11), and manages the existence confirmation result in association with the non-fungible token (SA12).

### (Flow of Process of Terminal Apparatus B1)

SB1 in FIG. 3 is a flowchart illustrating a flow of a process carried out by the terminal apparatus B1. As shown in FIG. 3, the terminal apparatus B1 executes the confirmation test which is for confirmation on existence of the subject (step SB11), and provides the response information given by the subject in response to the confirmation test to the generation apparatus that generates the existence confirmation result, which is the result of confirmation on existence of the subject and which is to be associated with the non-fungible token (step SB12).

### (Flow of Process of Management Apparatus C1)

SC1 in FIG. 3 is a flowchart illustrating a flow of a process carried out by the management apparatus C1. As shown in FIG. 3, the management apparatus C1 obtains the existence confirmation result, which is the result of confirmation on existence of the subject (step SC11), and manages the existence confirmation result in association with the non-fungible token (step SC12).

### (Flow of Process of Information Processing Apparatus D1)

SD1 in FIG. 4 is a flowchart illustrating a flow of a process carried out by the information processing apparatus D1. As shown in FIG. 4, the information processing apparatus D1 obtains the specifying information which is for specifying the non-fungible data including (i) the information indicating the existence confirmation result, which is the result of confirmation on existence of the subject, and (ii) the non-fungible token associated with the information indicating the existence confirmation result (step SD11), and manages the non-fungible data (step SD12).

### (Flow of Process of Information Processing Apparatus F1)

SF1 in FIG. 4 is a flowchart illustrating a flow of a process carried out by the information processing apparatus F1. As shown in FIG. 4, the information processing apparatus F1 obtains the specifying information which is for specifying the non-fungible token associated with the existence confirmation result, which is the result of confirmation on existence of the subject (step SF11), and executes the authentication process which refers to at least either of the existence confirmation result and the non-fungible token (step SF12).

### (Flow of Process of Entire Authentication System 1)

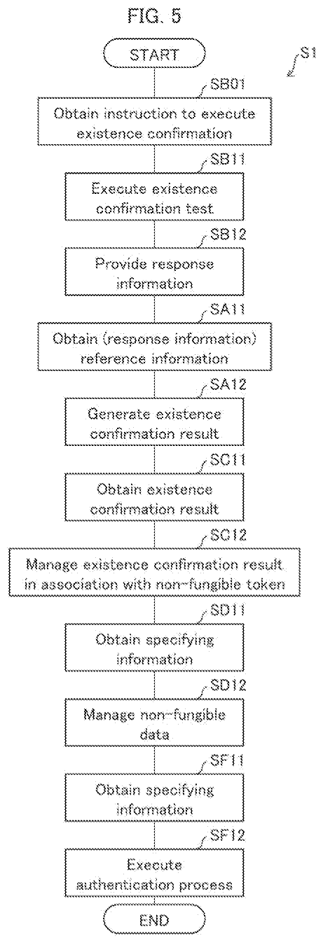

FIG. 5 is a flowchart illustrating a flow of a process of the entire authentication system 1.

### (Steps SB01 to SB12)

First, the terminal apparatus B1 obtains an instruction to execute existence confirmation (step SB01). Next, the terminal apparatus B1 executes the existence confirmation test (step SB11). Then, the terminal apparatus B1 provides, to the generation apparatus A1, the response information given by the subject in response to the existence confirmation test (step SB12).

### (Steps SA11 and SA12)

Subsequently, the generation apparatus A1 obtains the response information from the terminal apparatus B1 (step SA11). Then, the generation apparatus A1 generates the existence confirmation result with reference to the response information (step SA12).

### (Steps SC11 and SC12)

Subsequently, the management apparatus C1 obtains the existence confirmation result from the generation apparatus A1 (step SC11). Then, the management apparatus C1 manages the existence confirmation result in association with the non-fungible token (step SC12).

### (Steps SD11 and SD12)

Subsequently, the information processing apparatus D1 obtains, from the management apparatus C1, the specifying information which is for specifying the non-fungible token (step SD11). Then, the information processing apparatus D1 manages the non-fungible data including the non-fungible token specified by the specifying information (step SD12).

### (Steps SF11 and SF12)

Subsequently, the information processing apparatus F1 obtains, from the information processing apparatus D1, the specifying information which is for specifying the non-fungible token (step SF11). Then, the information processing apparatus F1 executes an authentication process which refers to the non-fungible data including the non-fungible token specified by the specifying information (step SF12).

The authentication system 1, which carries out the above-described processes, manages the non-fungible data including the non-fungible token and the existence confirmation result associated with the non-fungible token, and executes the authentication process which refers to the non-fungible data. Thus, it is possible to provide an authentication system which is fair and has high transparency.

### Second Example Embodiment

The following description will discuss a second example embodiment of the present invention in detail with reference to the drawings. Note that members having identical functions to those of the first example embodiment are given identical reference signs, and a description thereof will be omitted.

An authentication system in accordance with the present example embodiment includes a generation apparatus A1, a terminal apparatus B1, a management apparatus C1, an information processing apparatus D1, an information processing apparatus F1, and a distributed ledger system G1, as described in the first example embodiment. The following will describe specific configurations of the apparatuses included in the authentication system in accordance with the present example embodiment.

### (Generation Apparatus A1)

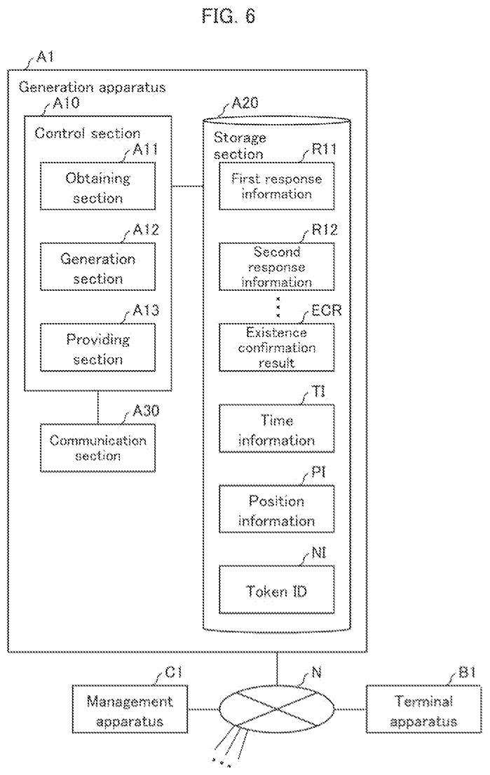

FIG. 6 is a block diagram illustrating a configuration of the generation apparatus A1. As shown in FIG. 6, the generation apparatus A1 includes a control section A10, a storage section A20, and a communication section A30.

The communication section A30 communicates with an apparatus external to the generation apparatus A1. In an example, the communication section A30 communicates with at least any one selected from the group consisting of the terminal apparatus B1, the management apparatus C1, and another apparatus included in the authentication system in accordance with the present example embodiment. Further, the communication section A30 transmits, to the external apparatus, data supplied from the communication section A10, and/or supplies, to the communication section A10, data received from the external apparatus.

### (Storage Section A20)

The storage section A20 stores therein various information referred to by the control section A10 and various information derived by the control section A10. In an example, the storage section A20 stores therein the followings:
first response information RI1 indicating a content of a response given by the subject in response to a first existence confirmation test executed by the terminal apparatus B1;
second response information RI2 indicating a content of a response given by the subject in response to a second existence confirmation test executed by the terminal apparatus B1;
an existence confirmation result ECR relating to the subject, the existence confirmation result ECR being generated (derived) by the generation section A12 with reference to at least either of the first response information RI1 and the second response information RI2;
time information TI indicating date and time when at least either of the first existence confirmation test and the second existence confirmation test was executed;
position information PI indicating a position (location) where at least either of the first existence confirmation test and the second existence confirmation test was executed; and
a token ID of a non-fungible token possessed by the subject.

### (Control Section A10)

As shown in FIG. 6, the control section A10 includes an obtaining section A11, a generation section A12, and a providing section A13.

### (Obtaining Section A11)

The obtaining section A11 obtains reference information which is for confirmation on existence of the subject. For example, the obtaining section A11 obtains, as the reference information, the first response information RI1 being supplied from the terminal apparatus B1 and indicating the content of the response given by the subject in response to the first existence confirmation test executed by the terminal apparatus B1. Further, the obtaining section A11 may obtain, as another reference information, the second response information RI2 being supplied from the terminal apparatus B1 and indicating the content of the response given by the subject in response to the second existence confirmation test executed by the terminal apparatus B1. Note that a specific example of the existence confirmation test executed by the terminal apparatus B1 will be described later.

Further, the obtaining section A11 may obtain, from the terminal apparatus B1, the followings:
the time information TI indicating the date and time when at least either of the first existence confirmation result and the second existence confirmation result was executed; and
the position information PI indicating the position (location) where at least either of the first existence confirmation test and the second existence confirmation test was executed.
   Then, the obtaining section A11 may store, in the storage section A20, the obtained time information TI and position information PI in association with a corresponding existence confirmation test.

Further, the obtaining section A11 may obtain the token ID of the non-fungible token possessed by the subject from, e.g., at least any one selected from the group consisting of the management apparatus C1, the information processing apparatus D1, and the terminal apparatus B1, and may store the obtained token ID in the storage section A20. Specifically, the “token ID” herein refers to, for example, a value uniquely derived from a combination of an ERC721 contract address and an issue number.

### (Generation Section A12)

The generation section A12 generates (derives), with reference to the reference information, the existence confirmation result, which is the result of confirmation on existence of the subject and which is to be associated with the non-fungible token. For example, the generation section A12 refers to the first response information RI1 obtained by the obtaining section A11, and generates the existence confirmation result relating to the subject. Further, the generation section A12 may further refer to the second response information RI2 obtained by the obtaining section A11, and may generate the existence confirmation result. The existence confirmation result ECR generated by the generation section A12 is stored in the storage section A20, for example.

In a specific example of the deriving process in which the generation section A12 derives the existence confirmation result, the generation section A12 may derive an existence confirmation result corresponding a degree of coincidence between a content of the subject's response included in the first response information RI1 and a content of a given response. This, however, is in no way intended to limit the present example embodiment.

For example, in a case where the degree of coincidence between the content of the subject's response included in the first response information RI1 and the content of the given response is not less than a given threshold, the generation section A12 may generate an existence confirmation result indicating successful passing of the first existence confirmation test. Further, the generation section A12 may be configured to incorporate, into the existence confirmation result, a score indicating the degree of coincidence between the content of the subject's response included in the first response information RI1 and the content of the given response.

Similarly, in a case where a degree of coincidence between a content of the subject's response included in the second response information RI2 and the content of the given response is not less than a given threshold, the generation section A12 may generate an existence confirmation result indicating successful passing of the second existence confirmation test. Further, the generation section A12 may be configured to incorporate, into the existence confirmation result, a score indicating the degree of coincidence between the content of the subject's response included in the second response information RI2 and the content of the given response.

### (Providing Section A13)

The providing section A13 provides the existence confirmation result ECR to the management apparatus C1 that manages the existence confirmation result ECR in association with the non-fungible token. For example, the providing section A13 provides, to the management apparatus C1, the existence confirmation result ECR together with the token ID of the non-fungible token associated with the existence confirmation result ECR. Further, the providing section A13 may provide, to the management apparatus, the time information which is to be associated with the non-fungible token. For example, the providing section A13 may provide the above-described time information TI to the management apparatus C1 as time information which is to be associated with the non-fungible token.

Further, the providing section A13 may provide, to the management apparatus, the position information which is to be associated with the non-fungible token. For example, the providing section A13 may provide the above-described position information PI to the management apparatus C1 as the position information which is to be associated with the non-fungible token.

Further, the providing section A13 may be configured to provide, to the terminal apparatus B1, the followings:
first test information TE1 which is referred to for execution of the above-described first existence confirmation test; and
second test information TE2 which is referred to for execution of the above-described second existence confirmation test.
   The first test information TE1 and the second existence confirmation test TE2 are referred to, for example, in order that the terminal apparatus B1 executes the first existence confirmation test and the second existence confirmation test.

### (Example of Data Provided by Providing Section A13)

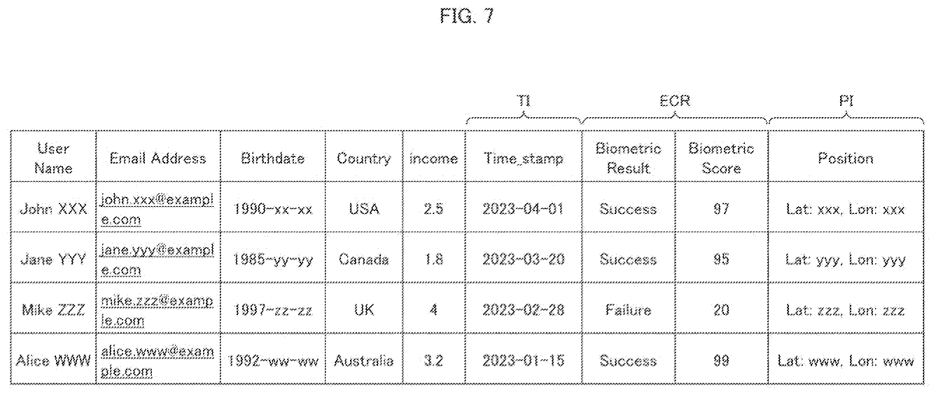

FIG. 7 shows an example of data that the providing section A13 provides to the management apparatus C1. As shown in FIG. 7, for example, the data provided by the providing section A13 includes the followings:
subject's name (user name);
subject's e-mail address;
subject's birthdate;
subject's country;
subject's income;
the time information TI (time stamp) indicating the date and time when the existence confirmation test was executed;
the position information PI (position) indicating the positon (location) where the existence confirmation test was executed; and
the existence confirmation result ECR.
   In the data, these pieces of information are associated with each other. Further, as shown in FIG. 7, the existence confirmation result ECR includes, for example, the followings:
information indicating whether or not the subject has successfully passed the existence confirmation test (whether biometric authentication, which is one example of the existence confirmation test, succeeded (success) or failed (failure) (biometric result); and
a biometric score, which is one example of the score of the existence confirmation test.

As described above, the generation apparatus A1 obtains the reference information which is for confirmation on existence of the subject, and generates the existence confirmation result of the subject with reference to the reference information. Here, the existence confirmation result generated by the generation apparatus A1 is information which is associated with the non-fungible token and is managed in a non-fungible manner. Therefore, with the above configuration, it is possible to provide an authentication system which is fair and has high transparency.

### (Terminal Apparatus B1)

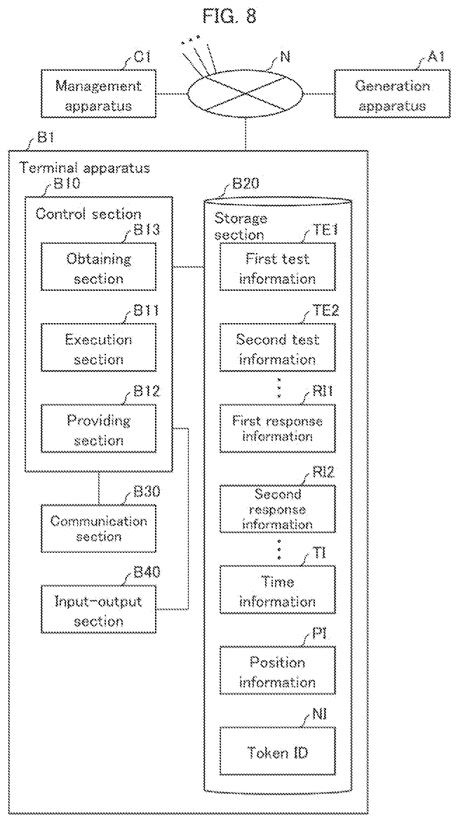

FIG. 8 is a block diagram illustrating a configuration of the terminal apparatus B1. As shown in FIG. 8, the terminal apparatus B1 includes a control section B10, a storage section B20, a communication section B30, and an input-output section B40.

The communication section B30 communicates with an apparatus external to the terminal apparatus B1. In an example, the communication section B30 communicates with at least any one selected from the group consisting of the generation apparatus A1, the management apparatus C1, and another apparatus included in the authentication system in accordance with the present example embodiment. Further, the communication section B30 transmits, to the external apparatus, data supplied from the communication section B10, and/or supplies, to the communication section B10, data received from the external apparatus.

The input-output section B40 includes, for example, an input-output device which is at least any one selected from the group consisting of a keyboard, a mouse, a display, a printer, a touch panel, a camera, a speaker, and the like. The input-output section B40 may include, instead of any of these input-output devices, an interface such as universal serial bus (USB), for example. Further, the interface may be connected to at least any one of the input-output devices.

The input-output section B40 accepts, from at least any one of the input-output devices, various information for the terminal apparatus B1. Further, under control of the control section B10, the input-output section B40 outputs various information to at least any one of the input-output devices.

### (Storage Section B20)

The storage section B20 stores therein various information referred to by the control section B10 and various information derived by the control section B10. In an example, the storage section B20 stores therein the followings:
the first test information TE1 and the second test information TE2 provided by the generation apparatus A1;
the first response information RI1 indicating the content of the response given by the subject in response to the first existence confirmation test executed with reference to the first test information;
the second response information RI2 indicating the content of the response given by the subject in response to the second existence confirmation test executed with reference to the second test information;
the time information TI indicating the date and time when at least either of the first existence confirmation test and the second existence confirmation test was executed;
the position information PI indicating the position (location) where at least either of the first existence confirmation test and the second existence confirmation test was executed; and
the token ID of the non-fungible token possessed by the subject.

### (Control Section B10)

As shown in FIG. 8, the control section B10 includes an obtaining section B13, an execution section B11, and a providing section B12.

### (Obtaining Section B13)

For example, the obtaining section B13 obtains, from the generation apparatus A1, the followings:
the first test information TE1 which is referred to for execution of the first existence confirmation test; and
the second test information TE2 which is referred to for execution of the second existence confirmation test.
   Then, the obtaining section B13 stores, in the storage section B20, the first test information TE1 and second test information TE2 thus obtained.

Further, for example, the obtaining section B13 may obtain, from the management apparatus C1, the following:

the specifying information (token ID) for specifying the non-fungible token associated with the existence confirmation result generated by the generation apparatus A1 with reference to at least either of the first test information TEL and the second test information TE2.

Then, the obtaining section B13 may store the obtained token ID in the storage section B20.

### (Execution Section B11, Providing Section B12)

The execution section B11 executes a confirmation test which is for confirmation on existence of the subject. For example, the execution section B11 executes the first existence confirmation test with reference to the first test information TE1. The execution section B11 may further execute the second existence confirmation test with reference to the second test information TE2.

The providing section B12 provides response information given by the subject in response to the confirmation test to the generation apparatus A1 that generates the existence confirmation result, which is the result of confirmation on existence of the subject and which is to be associated with the non-fungible token. For example, the providing section B12 provides, to the generation apparatus A1, the above-described first response information RI1 and second response information RI2. Further, the providing section B12 may provide, to the generation apparatus A1, at least either of the above-described time information TI and position information PI together with the existence confirmation result. The providing section B12 may provide, to the generation apparatus A1, the token ID in association with the existence confirmation result. The generation apparatus A1 causes the token ID to be associated with the existence confirmation result.

Note that the specifying process, carried out by the terminal apparatus B1, of specifying the position information PI of the terminal apparatus can employ, for example, position information specified by a measuring apparatus included in the terminal apparatus B1, position information specified by near field communication carried out by the terminal apparatus B1, position information specified by analysis on an image captured by a camera included in the terminal apparatus B1, and the like. This, however, is in no way intended to limit the present example embodiment.

A specific example of the existence confirmation test executed by the execution section B11 can be an existence confirmation test that employs at least any one of various biometric authentication techniques such as the followings:
face authentication;
iris authentication;
fingerprint authentication;
vein authentication; and
voice and/or speech authentication.
   This, however, is in no way intended to limit the present example embodiment.

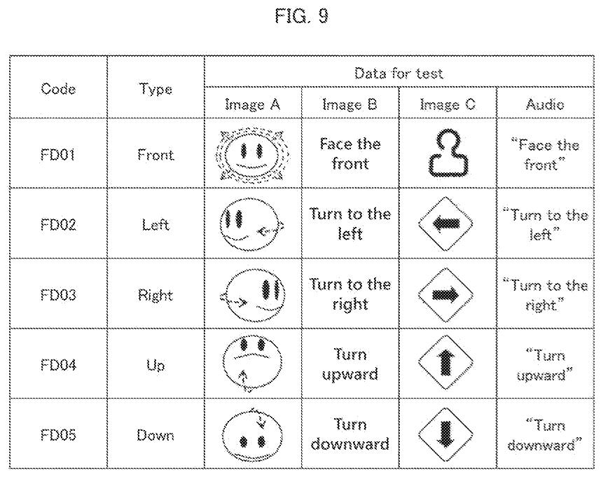

FIG. 9 is a view illustrating a specific example of the first existence confirmation test executed by the execution section B11.

The example shown in FIG. 9 illustrates the first existence confirmation test with which authentication of the subject is carried out with use of an orientation of a face. In the example shown in FIG. 9, four confirmation tests (which may sometimes be called “challenges”) (an image A, an image B, an image C, and audio) are classified according to the kinds, and the challenges of the same kind are associated with each other. The kinds are given respective “codes”, which are identifiers, and are given “types”, which are names. For example, among four challenges having the code “FD02” and the type “left”, an image A is an icon image showing a mirrored image of a left-oriented face; an image B is an image showing a character string “Turn to the left”; an image C is an arrow icon image giving an instruction to turn to the left; audio is audio data giving an instruction to turn to the left.

In the example shown in FIG. 9, the obtaining section B13 obtains, as the first test information TE1, data indicating the above-described image A, image B, image C, and audio. Further, in the example shown in FIG. 9, the execution section B11 executes a first existence confirmation test involving use of at least any one selected from the group consisting of the above-described image A, image B, image C, and audio.

In an example, the execution section B11 presents an image A of any of the types to the subject via a display included in the input-output section B40, and obtains, as first response information RI1, a content of a response given by the subject in response to the image A. The first response information RI1 can include captured image data including the subject's face captured by a camera included in the input-output section B40 at a timing of presenting the image A. The first response information RI1 including the captured image data is provided by the providing section B12 to, e.g., the generation apparatus A1.

In another example, the execution section B11 presents audio data included in the first response information TE1 to the subject via a speaker included in the input-output section B40, and obtains, as first response information RI1, a content of a response given by the subject in response to the image A. The first response information RI1 can include captured image data including the subject's face captured by the camera included in the input-output section B40 at a timing of presenting the audio. The first response information RI1 including the captured image data is provided by the providing section B12 to, e.g., the generation apparatus A1.

The generation section A12 of the generation apparatus A1 uses a given face authentication algorism to determine whether or not the subject's face indicated by the captured image data included in the first response information RI1 is identical to a face registered in advance. Further, the generation section A12 determines whether or not an orientation of the subject's face indicated by the captured image data coincides with a given orientation. Then, the generation section A12 generates an existence confirmation result corresponding to the determination result. The generation section A12 may calculate a score indicating:
a degree of coincidence between the subject's face indicated by the captured image data and the face registered in advance; and
a degree of coincidence between the orientation of the subject's face indicated by the captured image data and the given orientation.
   Then, the generation section A12 may incorporate the score into the existence confirmation result. An example of the existence confirmation result is as discussed with reference to FIG. 7.

In a case where the execution section B11 executes the above-described first existence confirmation test, the execution section B11 may execute, as a second existence confirmation test, an authentication test which is at least any one selected from the group consisting of iris authentication, fingerprint authentication, vein authentication, and voice and/or speech authentication.

In an example, the execution section B11 may urge, via the input-output section B40, the subject to capture an image of his/her iris. Then, the execution section B11 may obtain, as second response information RI2, captured image data including the subject's iris captured by the camera included in the input-output section B40. The second response information RI2 including the captured image data of the subject's iris is provided by the providing section B12 to the generation apparatus A1.

Then, the generation section A12 of the generation apparatus A1 determines whether or not the image of the iris indicated by the captured image data included in the second response information RI2 has a given structure, and generates an existence confirmation result corresponding to the determination result. The generation section A12 may calculate a score indicating a degree of coincidence between a structure of the subject's iris indicated by the captured image data and a structure of the subject's iris registered in advance, and may incorporate the score into the existence confirmation result.

Note that the timing that the execution section B11 executes the above-described existence confirmation test may be, for example, as follows. On the basis of an instruction from the management apparatus C1 that manages the existence confirmation result in association with the non-fungible token, the execution section B11 may carry out the existence confirmation test. This, however, is in no way intended to limit the present example embodiment.

For example, the management apparatus C1 may give, at a timing of issuing (minting) the non-fungible token, the terminal apparatus B1 an instruction to execute the existence confirmation test, and the execution section B11 may execute the existence confirmation test at that timing.

### (Management Apparatus C1)

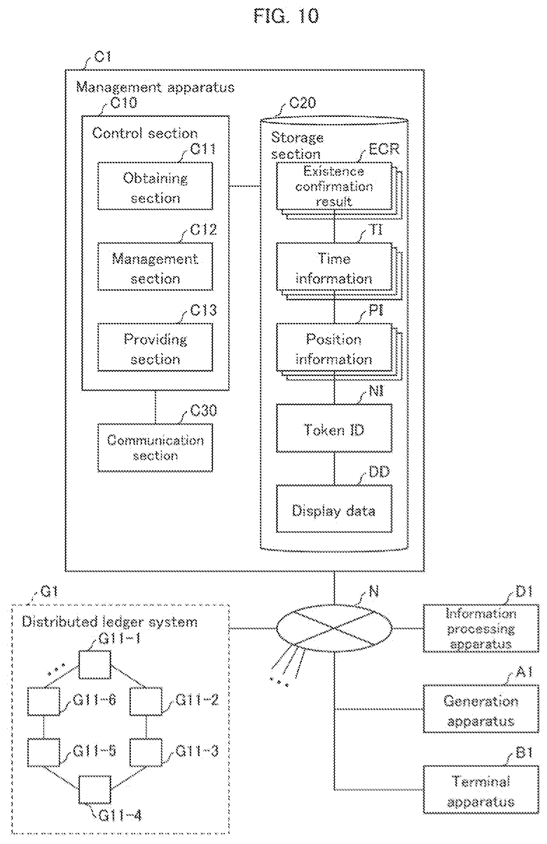

FIG. 10 is a block diagram illustrating a configuration of the management apparatus C1. As shown in FIG. 10, the management apparatus C1 includes a control section C10, a storage section C20, and a communication section C30.

The communication section C30 communicates with an apparatus external to the terminal apparatus B1. In an example, the communication section C30 communicates with at least any one selected from the group consisting of the generation apparatus A1, the terminal apparatus B1, the information processing apparatus D1, and another apparatus, such as the distributed ledger system G1, included in the authentication system in accordance with the present example embodiment. Further, the communication section C30 transmits, to the external apparatus, data supplied from the communication C10, and/or supplies, to the communication section C10, data received from the external apparatus.

### (Storage Section C20)

The storage section C20 stores therein various information referred to by the control section C10 and various information derived by the control section C10. In an example, the storage section C20 stores therein the followings:
one or more existence confirmation results ECR;
a piece(s) of time information TI associated with the one or more existence confirmation results ECR;
a piece(s) of position information PI associated with the one or more existence confirmation results ECR;
a token ID(s) of a non-fungible token(s) associated with the one or more existence confirmation results ECR; and
a piece(s) of display data DD associated with the non-fungible token(s).
   Here, as shown in FIG. 10, the management apparatus C1 may cause the plurality of existence confirmation results ECR with a single token ID. In an example, the followings may be associated with the same token ID:
an existence confirmation result ECR1 associated with time information TI1 and position information PI1; and
an existence confirmation result ECR2 associated with time information TI2 and position information PI2.
   These existence confirmation results indicate, for example, results of existence confirmation tests conducted by the same subject on different dates and times at different places.

Alternatively, the management apparatus C1 may associate one existence confirmation result ECR with a plurality of pieces of time information and a plurality of pieces of position information. With this configuration, the non-fungible data NFD managed by the management apparatus C1 can be used as data for showing a temporal change in position of the subject.

### (Control Section C10)

As shown in FIG. 10, the control section C10 includes an obtaining section C11, a management section C12, and a providing section C13.

### (Obtaining Section C11)

The obtaining section C11 obtains the existence confirmation result, which is the result of confirmation on existence of the subject. For example, the obtaining section C11 obtains the existence confirmation result ECR generated by the generation apparatus A1. Further, the obtaining section C11 may obtain at least either of the time information TI and position information PI associated with the existence confirmation result. The time information TI indicates the date and time when the existence confirmation test which is for deriving the existence confirmation result was executed, and the position information PI indicates the position (location) where the existence confirmation test was executed.

### (Management Section C12)

The management section C12 manages the existence confirmation result in association with the non-fungible token. For example, the obtaining section C11 manages the existence confirmation result ECR in association with the token ID of the non-fungible token. Further, the management section C12 may manage the existence confirmation result in association with at least either of the time information TI and the position information PI obtained by the obtaining section C11. Moreover, the management section C12 also functions as an issuing section that issues (mints) the non-fungible token. In an example, the management section C12 may determine a new token ID as specifying information which is for specifying a new non-fungible token.

Further, the obtaining section C11 may be configured to obtain an existence-confirmation-result-for-updating which is associated with newer time information, and the management section C12 may be configured to update, with use of the existence-confirmation-result-for-updating, the existence confirmation result associated with the non-fungible token.

Data managed by the management section C12 is registered in the block chain as transaction data, for example. Thus, the management section C12 can also be expressed as managing the data in a non-fungible manner.

Further, the management section C12 also functions as a display data generation section that generates display data DD associated with the non-fungible token. In other words, the management section C13 generates display data which is for the non-fungible token and which includes a display object corresponding to the existence confirmation result.

Note that the management section C12 may manage the non-fungible token as a token (soul bound token) which is set as being non-transferable. In an example, the management section C12 may be configured to register, via the providing section C13, the non-fungible token in the block chain as transaction data so that the non-fungible token is set as a non-transferable one.

### (Providing Section C13)

The providing section C13 registers, as transaction data, data (which may also be called non-fungible data NFD) including the existence confirmation result ECR and the non-fungible token NFT associated with the existence confirmation result in the block chain managed by the distributed ledger system G1. Here, the non-fungible data may include the above-described time information TI and position information PI.

Further, the providing section C13 may provide the token ID of the non-fungible token to another apparatus (e.g., the information processing apparatus D1, the generation apparatus A1, and/or the terminal apparatus B1) included in the authentication system in accordance with the present example embodiment.

Further, at any timing, the providing section C13 may give, to the terminal apparatus B1 or the generation apparatus A1, an instruction to execute the existence confirmation test. For example, at a timing that the management section C12 mints the non-fungible token, the providing section C13 may give, to the terminal apparatus B1 or the generation apparatus A1, the instruction to execute the existence confirmation test. Further, at a timing that the management section C12 updates the non-fungible token, the providing section C13 may give, to the terminal apparatus B1 or the generation apparatus A1, the instruction to execute the existence confirmation test.

### (Configuration Example of Non-Fungible Data)

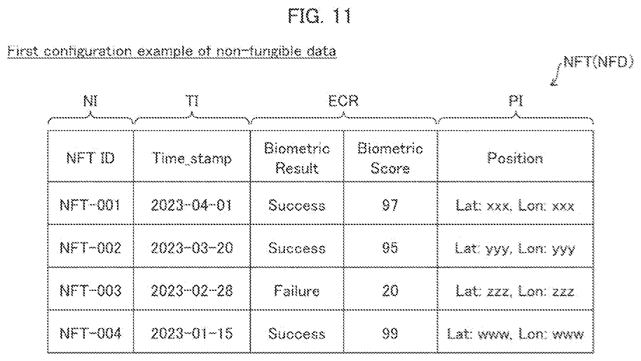

FIG. 11 illustrates a first configuration example of non-fungible data which is managed by the management section C12 and which is given a token ID by the providing section C13. In this configuration example, the followings are associated with each other:
a token ID (NFT ID) of a non-fungible token;
time information TI (time stamp);
an existence confirmation result ECR; and
position information PI (position).
   Further, as shown in FIG. 11, the existence confirmation result ECR includes, for example, the followings:
information indicating whether or not the subject has successfully passed the existence confirmation test (whether biometric authentication, which is one example of the existence confirmation test, succeeded (success) or failed (failure) (biometric result); and
a biometric score, which is one example of the score of the existence confirmation test.

Further, the example shown in FIG. 11 can be understood as follows:
The non-fungible data NFD includes the non-fungible token NFT designated by the token ID and the existence confirmation result associated with the token ID.
   In other words, the non-fungible data shown in FIG. 11 can be expressed as including:
the information indicating the existence confirmation result, which is the result of confirmation on existence of the subject; and
the non-fungible token associated with information indicating the existence confirmation result.

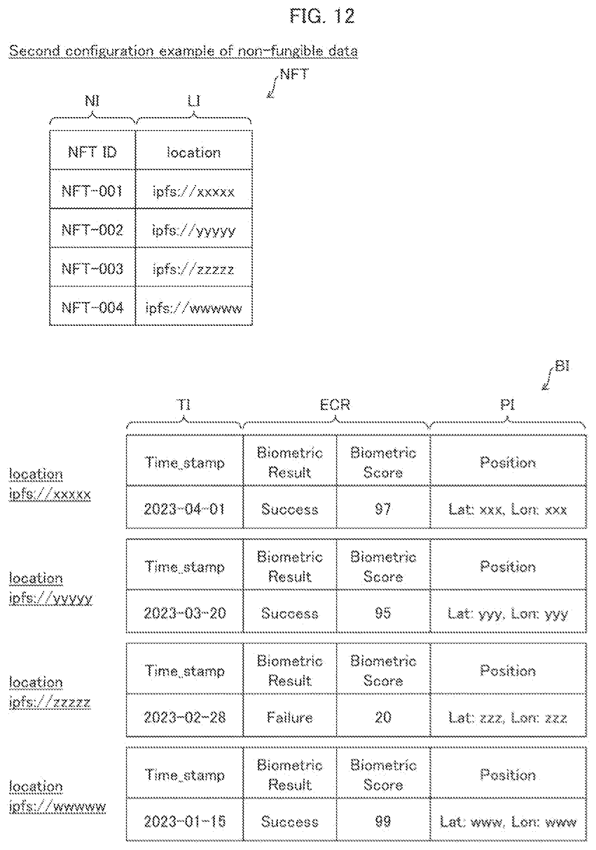

FIG. 12 illustrates a second configuration example of non-fungible data which is managed by the management section C12 and which is given a token ID by the providing section C13. In this configuration example, the non-fungible token NFT includes:
a token ID; and
location information LI.

In a storage destination designated by the location information LI, the followings are stored as storage data BI:
time information TI (time stamp);
an existence confirmation result ECR; and
position information PI (position).
   These pieces of data are stored in association with each other. Here, the storage destination may be a distributed storage destination. In this example, the non-fungible token NFT is registered as transaction data of the block chain (i.e., registered as being on-chain), and the storage destination designated by the location information LI indicates, for example, a storage destination which is outside the block chain (off-chain).

Thus, the non-fungible data NFD shown in FIG. 12 can be expressed as including, as off-chain information, information indicating the existence confirmation result, which is the result of confirmation on existence of the subject, and including, as on-chain information, the non-fungible token associated with information the existence indicating confirmation result.

Note that, as shown in FIGS. 11 and 12, the non-fungible data NFD in accordance with the present example embodiment does not include:
subject's name (user name);
subject's mail address (email address);
subject's birthdate;
subject's country; or
subject's income.
   With this configuration, even when the token ID is referred to, the above pieces of information relating to the subject associated with the token ID would not be revealed. Thus, with the above configuration, it is possible to openly manage data for authentication with use of the distributed ledger system while keeping the subject's privacy secret, advantageously.

Further, as described above, the management section C12 is configured to be capable of successively updating an existence confirmation result (and time information and position information) which is to be associated with the same token ID. Therefore, the management section C12 can manage, as the data for authentication of the subject, non-fungible data including a latest existence confirmation result. Such a configuration can also be expressed as the one managing an existence confirmation result of the subject as dynamic NFT. This, however, is in no way intended to limit the present example embodiment.

### (Distributed Ledger System G1)

Next, the following will described the distributed ledger system G1 in accordance with the present example embodiment. Similarly to the first example embodiment, the distributed ledger system G1 in accordance with the present example embodiment includes a plurality of nodes G11-1, G11-2, . . . .

Here, each of the nodes G11-1, G11-2, . . . , stores therein a block chain, which is one example of a distributed ledger. Further, at least any one of the blocks included in the block chain stores therein, as transaction data, the non-fungible data NFD managed by the above-described management apparatus C1 or the like.

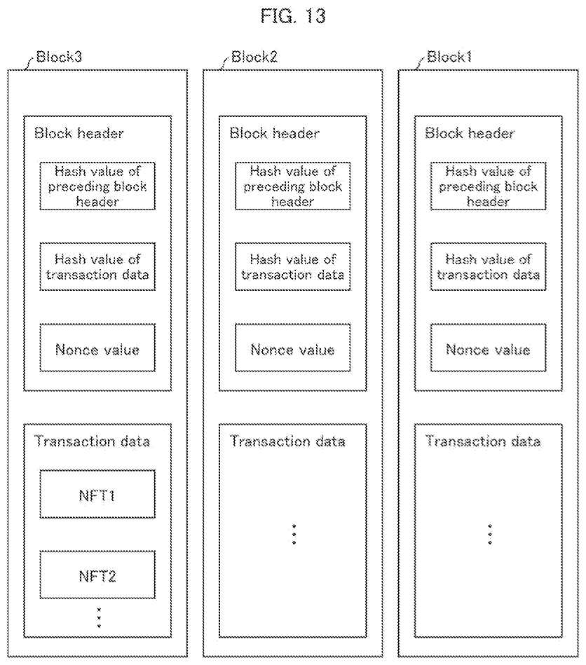

FIG. 13 is a view illustrating a block chain BC in which blocks including transaction data are registered by the respective nodes. As shown in FIG. 13, the block chain BC includes a plurality of blocks ( . . . , Block 1, Block 2, and Block 3), and each of the blocks includes a block header and transaction data. As shown in FIG. 13, the block header includes, for example, a hash value of a block header of a preceding block, a hash value of transaction data of that block header, and a nonce value. Since each block includes a hash value of a block immediately before that block, an order of the blocks is defined.

In an example, each node of the distributed ledger system G1 carries out the following process in order to register the block in the block chain BC:
specifying transaction data to be added to the block, and calculating a hash value of the transaction data thus specified;
calculating a hash value of a preceding block;
calculating a nonce value specifying a given condition.

Then, the node generates a block header including the hash value of the transaction data, the hash value of the preceding block, and the nonce value. Then, the node generates a block including the generated block header and the transaction data. The node broadcasts the generated block to another node in the distributed ledger system G1. Then, if the another node approves the block according to a given consensus algorithm, the node registers the block in the block chain BC.

FIG. 13 illustrates a block (Block 3) including transaction data including a token ID (NFT1) of a non-fungible token associated with an existence confirmation result of a first subject and a token ID (NFT2) of a non-fungible token associated with an existence confirmation result of a second subject. The block may be configured to include, in addition to the token ID, an existence confirmation result ECR associated with the token ID, time information TI, and position information PI.

Note that, in each of the nodes in the distributed ledger system G1, a program for executing the functions of the apparatuses included in the authentication system in accordance with the present example embodiment (a program for executing a smart contract corresponding to the functions) may be deployed. Further, the functions of the authentication system in accordance with the present example embodiment can be realized by the program. This, however, is in no way intended to limit the present example embodiment.

The block chain managed by the distributed ledger system G1 uses a system that has high tampering resistance and that allows data to be browed from outside. Thus, use of the distributed ledger system G1 makes it possible to provide an authentication system which is fair and has high transparency.

### (Information Processing Apparatus D1)

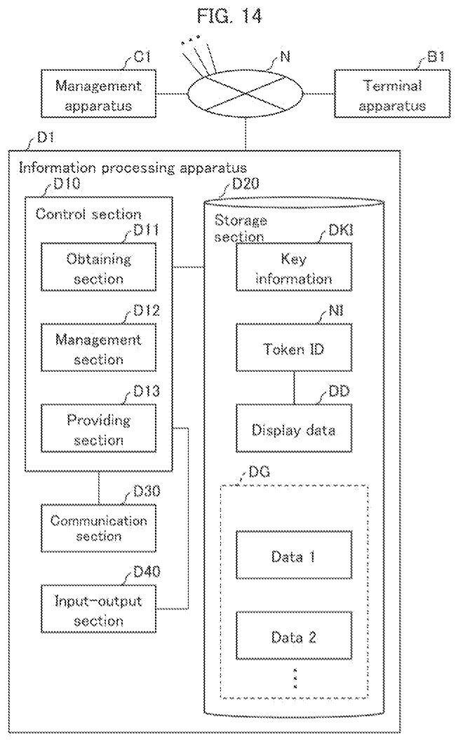

FIG. 14 is a block diagram illustrating a configuration of the information processing apparatus D1. As shown in FIG. 14, the information processing apparatus D1 includes a control section D10, a storage section D20, a communication section D30, and an input-output section D40. In an example, the information processing apparatus D1 is an apparatus that is operated by the subject (user). This, however, is in no way intended to limit the present example embodiment.

The communication section D30 communicates with an apparatus external to the information processing apparatus D1. In an example, the communication section D30 communicates with at least any one selected from the group consisting of the terminal apparatus B1, the management apparatus C1, and another apparatus (e.g., the information processing apparatus F1) included in the authentication system in accordance with the present example embodiment. Further, the communication section D30 transmits, to the external apparatus, data supplied from the communication section D10, and/or supplies, to the communication section D10, data received from the external apparatus.

The input-output section D40 includes, for example, an input-output device which is at least any one selected from the group consisting of a keyboard, a mouse, a display, a printer, a touch panel, a camera, a speaker, and the like. The input-output section D40 may include, instead of any of these input-output devices, an interface such as universal serial bus (USB), for example. Further, the interface may be connected to at least any one of these input-output devices.

The input-output section D40 accepts, from at least any one of the input-output devices, various information for the information processing apparatus D1. Further, under control of the control section D10, the input-output section D40 outputs various information to at least any one of the input-output devices.

### (Storage Section D20)

The storage section D20 stores therein various information referred to by the control section D10 and various information derived by the control section D10. In an example, the storage section D20 stores therein the followings, for example:
key information KI for encrypting a token ID;
the token ID;
display data DD associated with the token ID; and
a service data group DG supplied from the later-described information processing apparatus F1.

### (Control Section D10)

As shown in FIG. 14, the control section D10 includes an obtaining section D11, a management section D12, and a providing section D13.

### (Obtaining Section D11)

The obtaining section D11 obtains the specifying information which is for specifying the non-fungible data the information indicating the existence including (i) confirmation result, which is the result of confirmation on existence of the subject, and (ii) the non-fungible token associated with the information indicating the existence confirmation result. For example, the obtaining section D11 obtains, as the specifying information, the token ID of the non-fungible token, and stores the obtained token ID in the storage section D20.

Here, the existence confirmation result ECR associated with the non-fungible token includes, as described above, at least any one of the followings:
the time information TI associated with the existence confirmation result ECR;
the position information PI associated with the existence confirmation result ECR; and
the score of the existence confirmation test.
   Further, the existence confirmation result ECR is referred to in the authentication process carried out by the information processing apparatus F1, which will be described later. The information processing apparatus F1 provides a service to the subject in accordance with a result of the authentication process.

### (Management Section D12)

The management section D12 manages the non-fungible data. In an example, the management section D12 manages a token ID of a non-fungible token associated with the non-fungible data. The token ID managed by the management section D12 is supplied from the management apparatus C1, for example. Further, the non-fungible token indicated by the token ID managed by the management section D12 is, for example, a token set to be non-transferable. Moreover, the management section D12 manages the display data DD generated by the management apparatus C1 and associated with the token ID.

Note that the management section D12 may be configured to manage also a non-fungible token other than the non-fungible token included in the non-fungible data including the existence confirmation result.

### (Providing Section D13)

The providing section D13 provides specifying information which is for specifying the non-fungible token. In an example, the providing section D13 provides, as the specifying information, the token ID to the later-described information processing apparatus F1.

Here, in a specific example of the providing process carried out by providing section D13, the providing section D13 provides the token ID having been encrypted with use of the above-described key information KI to the information processing apparatus F1 or another apparatus included in the authentication system in accordance with the present example embodiment. This, however, is in no way intended to limit the present example embodiment. Further, in a specific example of the encryption process carried out by the providing section D13, the providing section D13 can employ a configuration carrying out the followings:
managing a secret key as the key information KI;
generating a public key from the secret key according to a given algorism;
providing the generated public key to the information processing apparatus F1 or another apparatus; and
providing the token ID having been encrypted with use of the secret key to the information processing apparatus F1 or another apparatus.
   This, however, is in no way intended to limit the present example embodiment. The information processing apparatus D1 or the another apparatus can use the public key to decrypt the token ID or confirm validity of the token ID.

Note that part of the processes carried out by the management section D12 and the providing section D13 can be expressed as being part of a so-called wallet function. This, however, is in no way intended to limit the present example embodiment.

### (Example of Display Data DD)

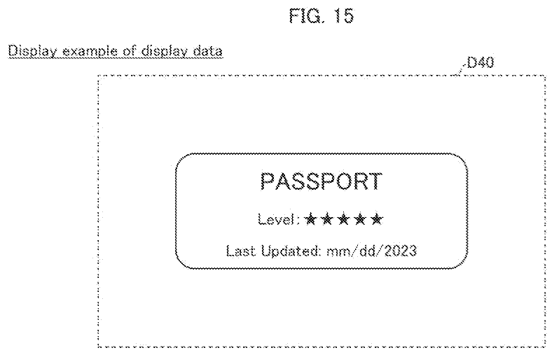

FIG. 15 is a view illustrating an example of display data DD which is generated by the management apparatus C1 and which is managed by the management section D12. As shown in FIG. 15, the display data DD includes, for example, the followings:
a character string indicating that data associated with the display data DD is non-fungible data (in the example shown in FIG. 15, “PASSPORT”);
latest date and time of the non-fungible data associated with the display data DD (in the example shown in FIG. 15, “Last Updated: mm/dd/2023”); and
a level given to the non-fungible data associated with the display data DD (in the example shown in FIG. 15, “Level: ★★★★★”).
   In an example, the management apparatus C1 may be configured to give a higher level to the non-fungible data, as the update date and time of the non-fungible data is closer to current date and time. Further, in such a configuration, a degree of closeness of the update date and time to the current date and time can be represented by the level. Thus, the display data DD may not include the update date and time (Last Updated: mm/dd/2023) but include the level (Level:★★★★★). Note that, in the above-described example, the value of the level is represented by the number of stars. This, however, is in no way intended to limit the present example embodiment. Alternatively, the level may be represented by a number.

In another example, the management apparatus C1 may be configured to give a higher level to the non-fungible data, as the value of the score included in the non-fungible data is higher. With such a configuration, it is possible to present the score to the user in an effective manner.

Further, the display data DD may be configured to include an icon (image), instead of or together with the above-described update date and time or level. Here, the icon may be configured to be allow the user to identify the update date and time or level by the color, shape, size, and/or the like of the icon (image), for example.

### (Information Processing Apparatus F1)

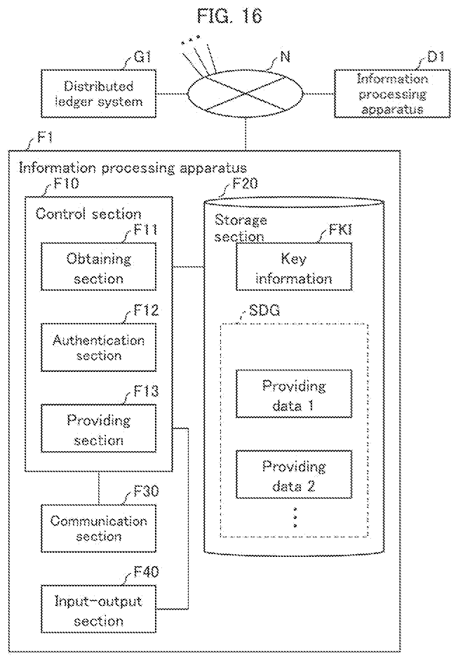

FIG. 16 is a block diagram illustrating a configuration of the information processing apparatus F1. As shown in FIG. 16, the information processing apparatus F1 includes a control section F10, a storage section F20, a communication section F30, and an input-output section F40. In an example, the information processing apparatus F1 is an apparatus that provides a service to a subject (user). This, however, is in no way intended to limit the present example embodiment.

The communication section F30 communicates with an apparatus external to the information processing apparatus F1. In an example, the communication section F30 communicates with at least any one selected from the group consisting of the information processing apparatus D1, the distributed ledger system G1, and another apparatus included in the authentication system in accordance with the present example embodiment. Further, the communication section F30 transmits, to the external apparatus, data supplied from the communication section F10, and/or supplies, to the communication section F10, data received from the external apparatus.

The input-output section F40 includes, for example, an input-output device which is at least one selected from the group consisting of a keyboard, a mouse, a display, a printer, a touch panel, a camera, a speaker, and the like. The input-output section F40 may include, instead of any of these input-output devices, an interface such as universal serial bus (USB), for example. Further, the interface may be connected to at least any one of these input-output devices.

The input-output section F40 accepts, from at least any one of the input-output devices, various information for the information processing apparatus F1. Further, under control of the control section F10, the input-output section F40 outputs various information to at least any one of the input-output devices.

### (Storage Section F20)

The storage section F20 stores therein various information referred to by the control section F10 and various information derived by the control section F10. In an example, the storage section F20 stores therein the followings, for example:
key information FKI for decrypting a token ID supplied from the information processing apparatus D1; and
a service data group SDG to be provided to the information processing apparatus D1.

### (Control Section F10)

As shown in FIG. 16, the control section F10 includes an obtaining section F11, a management section F12, and a providing section F13.

### (Obtaining Section F11)

The obtaining section F11 obtains specifying information which is for specifying the non-fungible token associated with the existence confirmation result, which is the result of confirmation on existence of the subject. For example, the obtaining section F11 obtains, as the specifying information, a token ID of the non-fungible token. In a specific example of the obtaining process in which the obtaining section F11 obtains the specifying information, the obtaining section F11 may employ a configuration carrying out the followings:
obtaining the token ID having been encrypted by the information processing apparatus D1 with use of the secret key; and
decrypting the obtained token ID with use of a public key.
   This, however, is in no way intended to limit the present example embodiment.

Further, the obtaining section F11 may further obtain at least either of the time information TI and the position information PI corresponding to the existence confirmation result associated with the token ID.

### (Authentication Section F12)

The authentication section F12 executes an authentication process which refers to at least either of the existence confirmation result and the non-fungible token. Further, the authentication section F12 may execute the authentication process which further refers to at least either of the time information TI and position information PI obtained by the obtaining section F11. Moreover, the existence confirmation result may include the score relating to confirmation on existence, and the authentication section F12 may be configured to execute the authentication process which further refers to the score.

### (Providing Section F13)

The providing section F13 provides a service to the subject in accordance with a result of the authentication process carried out by the authentication section F12. Here, specific examples of the service to be provided by the providing section F13 include services such as a game, a financial service, business support, information delivery, medical health care, and a personnel service. However, they are in no way intended to limit the present example embodiment. In accordance with the result of the authentication carried out by the authentication section F12, the providing section F13 provides data and/or the like relating to any of these services to a terminal (the terminal apparatus B1, the information processing apparatus D1, or the like) possessed by the user.

### (Examples of Authentication Process and Providing Process)

The following will describe an example of the authentication process carried out by the authentication section F12 and an example of the providing process carried out by the providing section F13.

### Example 1

In a case where the authentication section F12 determines that:
the score included in the existence confirmation result of the subject associated with the non-fungible token specified by the token ID obtained by the obtaining section F11 is not less than 60; and
the time information TI associated with the existence confirmation result is not time information of one or more days earlier,
   the providing section F13 permits log-in from the information processing apparatus D1, which is a supplier of the token ID, and provides a social networking service to the information processing apparatus D1.

### Example 2

In a case where the authentication section F12 determines that:
the score included in the existence confirmation result of the subject associated with the non-fungible token specified by the token ID obtained by the obtaining section F11 is not less than 50;
the time information TI associated with the existence confirmation result is time information within a year; and
the subject possesses another non-fungible token issued by a management entity of the service,
   the providing section F13 permits log-in from the information processing apparatus D1, which is a supplier of the token ID, and provides game data to the information processing apparatus D1.

### Example 3

In a case where the authentication section F12 determines that:
the score included in the existence confirmation result of the subject associated with the non-fungible token specified by the token ID obtained by the obtaining section F11 is not less than 90; and
the time information TI associated with the existence confirmation result is time information within three hours, the providing section F13 permits log-in from the information processing apparatus D1, which is a supplier of the token ID, and provides a financial service to the information processing apparatus D1.

### Example 4

In a case where the authentication section F12 determines that:
the time information TI and position information PI associated with the non-fungible token specified by the token ID obtained by the obtaining section F11 indicate that the subject (terminal apparatus B1) has moved along a given route at a given timing, the providing section F13 provides, to the information processing apparatus D1, a service which is to be given at the time of ending a stamp rally.

### Example 5

In a case where the authentication section F12 determines that:
the time information TI and position information PI associated with the non-fungible token specified by the token ID obtained by the obtaining section F11 indicate that the subject was at a given location on given date and time (time slot),
   the providing section F13 notifies a working management apparatus (or an attendance management apparatus) that the subject worked (or the subject was participated in a lecture or the like) on the date and time.

### Example 6

In a case where the authentication section F12 determines that:
the time information TI and position information PI associated with the non-fungible token specified by the token ID obtained by the obtaining section F11 indicate that the subject has moved from a place A to a place B along a given route within a given period of time,
   the providing section F13 charges, to the subject, a transportation fare of a transportation system for a section from the place A to the place B.

As described above, the information processing apparatus F1 obtains the specifying information which is for specifying the non-fungible token associated with the existence confirmation result, which is the result of confirmation on existence of the subject, and executes the authentication process which refers to at least either of the existence confirmation result and the non-fungible token. Therefore, with the above configuration, it is possible to provide an authentication system which is fair and has high transparency.

Note that the information processing apparatus F1 can carry out the above-described authentication process according to a rule determined in advance. Alternatively, the information processing apparatus F1 may dynamically switch a criteria for the authentication process. The following will describe an example of a method for switching the authentication process.

When the user carries out confirmation on existence, reliability of the user is enhanced, advantageously. However, frequent updating and/or requesting a too high authentication score requires the user to carry out authentication repeatedly, which gives a burden on the user. This may impair user satisfaction.

The information processing apparatus F1 may use an existing machine learning technique and/or an optimization method to switch an authentication criteria. In an example, the information processing apparatus F1 may use a machine learning model that receives, as an input, a score and/or time information relating to confirmation on existence of a user and determines whether or not the user is a bot (or a robot or an automated program). Such a machine learning model can be subjected to learning, in advance, with use of learning data including (i) the score and/or time information relating to confirmation on existence of the user and (ii) a correct label indicating whether or not the user is a bot (or a robot or an automated program).

The information processing apparatus F1 uses such a machine learning model to search (optimize) a criteria for a simple authentication process within a range in which a rate of exclusion of a bot is not less than a certain threshold. In other words, the control section F10 of the information processing apparatus F1 may be configured to optimize the condition of the authentication process on the basis of the machine learning model that has learned a relation between the existence confirmation result of the subject and the label (correct label).

Thus, by using the machine learning model generated on the basis of past data, the information processing apparatus F1 can set an authentication criteria with which the load on user can be reduced as much as possible and which can exclude a bot.

### [Example of Application to Health Care Service]

Further, the information processing apparatus F1 may use data of NFT including specific information which is managed by a wallet.

Specifically, according to the technique of the present example embodiment, it is possible to secure reliability of a wallet possessed by the user. An entity providing a service may provide the service by utilizing information stored in the wallet having high reliability.

For example, the information processing apparatus F1 may obtain, from the wallet, information relating to NFT (called “health care token”) in which data required for diagnosis (e.g., data indicating a heart rate) is registered. By utilizing the data of the health care token stored in the reliable wallet, the service provider can provide various health care services to a user. With this, it is possible to provide a service efficiently and correctly while protecting safety and privacy of individual's health information.

### [Software Implementation Example]

Part of or the whole of the functions of the generation apparatus A1, the terminal apparatus B1, the management apparatus C1, the information processing apparatus D1, the information processing apparatus F1, and the node G11 can be realized by hardware such as an integrated circuit (IC chip) or can be alternatively realized by software.

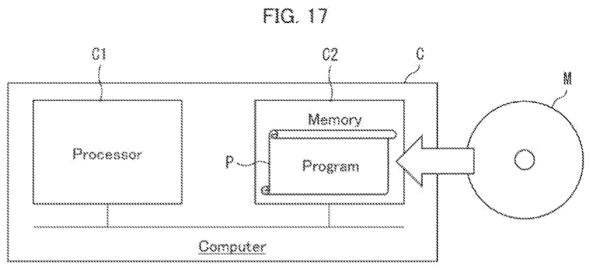

In the latter case, each of the generation apparatus A1, the terminal apparatus B1, the management apparatus C1, the information processing apparatus D1, the information processing apparatus F1, and the node G11 is realized by, for example, a computer that executes instructions of a program that is software realizing the foregoing functions. FIG. 17 shows an example of such a computer (hereinafter, referred to as a “computer C”). The computer C includes at least one processor C1 and at least one memory C2. The memory C2 has a program P stored therein, the program P causing the computer C to operate as the generation apparatus A1, the terminal apparatus B1, the management apparatus C1, the information processing apparatus D1, the information processing apparatus F1, and the node G11. In the computer C, the processor C1 reads and executes the program P from the memory C2, thereby realizing the functions of the generation apparatus A1, the terminal apparatus B1, the management apparatus C1, the information processing apparatus D1, the information processing apparatus F1, and the node G11.

The processor C1 may be, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of any of them. The memory C2 may be, for example, a flash memory, hard disk drive (HDD), solid state drive (SSD), or a combination of any of them.

The computer C may further include a random access memory (RAM) in which the program P is loaded when executed and various data is temporarily stored. In addition, the computer C may further include a communication interface via which the computer C transmits/receives data to/from another device. The computer C may further include an input-output interface via which the computer C is connected to an input-output device such as a keyboard, a mouse, a display, and/or a printer.

The program P can be stored in a non-transitory, tangible storage medium M capable of being read by a computer C. Examples of the storage medium M encompass a tape, a disk, a card, a memory, a semiconductor memory, and a programmable logic circuit. The computer C can obtain the program P via the storage medium M. Alternatively, the program P can be transmitted via a transmission medium. Examples of such a transmission medium encompass a communication network and a broadcast wave. The computer C can also obtain the program P via the transmission medium.

### [Supplementary Remarks 1]

The present invention is not limited to the foregoing example embodiments, but can be altered by a skilled person in the art within the scope of the claims. The present invention also encompasses, in its technical scope, any embodiment derived by combining technical means disclosed in differing embodiments.

### [Supplementary Remarks 2]

Some or all of the foregoing example embodiments can be described as below. Note, however, that the present invention is not limited to aspects described below.

### (Supplementary Note C1)

A management apparatus including:
an obtaining means that obtains an existence confirmation result, which is a result of confirmation on existence of a subject; and
a management means that manages the existence confirmation result in association with a non-fungible token.

### (Supplementary Note C2)

The management apparatus described in Supplementary Note C1, wherein:

the management means includes an issuing means that issues the non-fungible token.

### (Supplementary Note C3)

The management apparatus described in Supplementary Note C1 or C2, wherein:
the obtaining means obtains time information associated with the existence confirmation result; and
the management means manages the existence confirmation result in association with the time information.

### (Supplementary Note C4)

The management apparatus described in any one of Supplementary Notes C1 to C3, wherein:
the obtaining means obtains position information; and
the management means manages the existence confirmation result in association with the position information.

### (Supplementary Note C5)

The management apparatus described in any one of Supplementary Notes C1 to C4, wherein:

the existence confirmation result includes a score relating to the confirmation on the existence.

### (Supplementary Note C6)

The management apparatus described in any one of Supplementary Notes C1 to C5, wherein:
the obtaining means obtains an existence-confirmation-result-for-updating; and
the management means updates, with use of the existence-confirmation-result-for-updating, the existence confirmation result associated with the non-fungible token.

### (Supplementary Note C7)

The management apparatus described in any one of Supplementary Notes C1 to C6, wherein:

the management means generates display data which is for the non-fungible token and which includes a display object corresponding to the existence confirmation result.

### (Supplementary Note C8)

The management apparatus described in any one of Supplementary Notes C1 to C7, wherein:

the non-fungible token is a token set to be non-transferable.

### (Supplementary Note A1)

A generation apparatus including:
an obtaining means that obtains reference information which is for confirmation on existence of a subject; and
a generation means that generates, with reference to the reference information, an existence confirmation result, which is a result of confirmation on existence of the subject and which is to be associated with a non-fungible token.

### (Supplementary Note A2)

The generation apparatus described in Supplementary Note A1, wherein:

the obtaining means obtains, from a terminal apparatus that carries out an existence confirmation test on the subject, the reference information as response information given by the subject in response to the existence confirmation test.

### (Supplementary Note A3)

The generation apparatus described in Supplementary Note A1 or A2, further including:

a providing means that provides the existence confirmation result to a management apparatus that manages the existence confirmation result in association with the non-fungible token.

### (Supplementary Note A4)

The generation apparatus described in Supplementary Note A3, wherein:

the providing means provides, to the management apparatus, time information which is to be associated with the non-fungible token.

### (Supplementary Note A5)

The generation apparatus described in Supplementary Note A3 or A4, wherein:

the providing means provides, to the management apparatus, position information which is to be associated with the non-fungible token.

### (Supplementary Note A6)

The generation apparatus described in any one of Supplementary Notes A1 to A5, wherein:

the existence confirmation result includes a score relating to the confirmation on the existence.

### (Supplementary Note A7)

The generation apparatus described in any one of Supplementary Notes A1 to A6, wherein:
the obtaining means further obtains another reference information; and
the generation means generates the existence confirmation result with reference to the another reference information.

### (Supplementary Note B1)

A terminal apparatus including:
an execution means that executes a confirmation test which is for confirmation on existence of the subject; and
a providing means that provides, to a generation apparatus, response information given by the subject in response to the confirmation test, the generation apparatus generating an existence confirmation result, which is a result of confirmation on existence of the subject and which is to be associated with a non-fungible token.

### (Supplementary Note B2)

The terminal apparatus described in Supplementary Note B1, wherein:

the confirmation test includes a test regarding authentication of a living body.

### (Supplementary Note B3)

The terminal apparatus described in Supplementary Note B1 or B2, wherein:

the providing means provides, to the generation apparatus, time information indicating a time when the confirmation test was executed.

### (Supplementary Note B4)

The terminal apparatus described in any one of Supplementary Notes B1 to B3, wherein:

the providing means provides, to the generation apparatus, position information of the terminal apparatus.

### (Supplementary Note B5)

The terminal apparatus described in any one of Supplementary Notes B1 to B4, wherein:
the execution means further executes another confirmation test which is for confirmation on existence of the subject; and
the providing means provides response information given by the subject in response to the another confirmation test.

### (Supplementary Note B6)

The terminal apparatus described in any one of Supplementary Notes B1 to B5, wherein:

the execution means carries out the confirmation test on a basis of an instruction from a management apparatus that manages the existence confirmation result in association with the non-fungible token.

### (Supplementary Note B7)

The terminal apparatus described in any one of Supplementary Notes B1 to B6, further including:
an obtaining means that obtains specifying information which is for specifying the non-fungible token associated with the existence confirmation result, wherein
the providing means provides the specifying information to the generation apparatus.

### (Supplementary Note D1)

An information processing apparatus including:
an obtaining means that obtains specifying information which is for specifying non-fungible data including (i) information indicating an existence confirmation result, which is a result of confirmation on existence of a subject, and (ii) a non-fungible token associated with the information indicating the existence confirmation result; and
a management means that manages the non-fungible data.

### (Supplementary Note D2)

The information processing apparatus described in Supplementary Note D1, further including:

a providing means that provides specifying information which is for specifying the non-fungible token.

### (Supplementary Note D3)

The information processing apparatus described in Supplementary Note D1 or D2, wherein:

the non-fungible data includes time information associated with the existence confirmation result.

### (Supplementary Note D4)

The information processing apparatus described in any one of Supplementary Notes D1 to D3, wherein:

the non-fungible data includes position information.

### (Supplementary Note D5)

The generation apparatus described in any one of Supplementary Notes D1 to D4, wherein:

the existence confirmation result includes a score relating to the confirmation on the existence.

### (Supplementary Note D6)

The generation apparatus described in any one of Supplementary Notes D1 to D5, wherein:

the existence confirmation result is referred to in an authentication process carried out by the information processing apparatus, and the information processing apparatus provides a service to the subject in accordance with a result of the authentication process.

### (Supplementary Note D7)

The management apparatus described in any one of Supplementary Notes D1 to D6, wherein:

the non-fungible token is a token set to be non-transferable.

### (Supplementary Note F1)

An information processing apparatus including:
an obtaining means that obtains specifying information which is for specifying a non-fungible token associated with an existence confirmation result, which is a result of confirmation on existence of a subject; and
an authentication means that executes an authentication process which refers to at least either of the existence confirmation result and the non-fungible token.

### (Supplementary Note F2)

The information processing apparatus described in Supplementary Note F1, wherein:
the obtaining means further obtains time information associated with the existence confirmation result; and
the authentication means carries out the authentication process which further refers to the time information.

### (Supplementary Note F3)

The information processing apparatus described in Supplementary Note F1 or F2, wherein:
the obtaining means further obtains position information associated with the existence confirmation result; and
the authentication means carries out the authentication process which further refers to the position information.

### (Supplementary Note F4)

The information processing apparatus described in any one of Supplementary Notes F1 to F3, wherein:
the existence confirmation result includes a score relating to the confirmation on the existence; and
the authentication means carries out the authentication process which further refers to the score.

### (Supplementary Note F5)

The information processing apparatus described in any one of Supplementary Notes F1 to F4, further including:

a providing means that provides a service to the subject in accordance with a result of the authentication process.

### (Supplementary Note F6)

The information processing apparatus described in any one of Supplementary Notes F1 to F5, wherein:

a condition of the authentication process is optimized on a basis of a machine learning model that has learned a relation between the existence confirmation result of the subject and a label.

### (Supplementary Note E1)

A data structure including:
information indicating an existence confirmation result, which is a result of confirmation on existence of a subject, and
a non-fungible token associated with information indicating the existence confirmation result.

### (Supplementary Note E2)

The information processing apparatus described in Supplementary Note E1, wherein:

the non-fungible data includes time information associated with the existence confirmation result.

### (Supplementary Note E3)

The information processing apparatus described in Supplementary Note E1 or E2, wherein:

the non-fungible data includes position information.

### (Supplementary Note E4)

The generation apparatus described in any one of Supplementary Notes E1 to E3, wherein:

the existence confirmation result includes a score relating to the confirmation on the existence.

### (Supplementary Note E5)

The generation apparatus described in any one of Supplementary Notes E1 to E4, wherein:

the existence confirmation result is referred to in an authentication process carried out by the information processing apparatus, and the information processing apparatus provides a service to the subject in accordance with a result of the authentication process.

### (Supplementary Note E6)

The management apparatus described in any one of Supplementary Notes E1 to E5, wherein:

the non-fungible token is a token set to be non-transferable.

### (Supplementary Note SC1)

A management method including:
obtaining an existence confirmation result, which is a result of confirmation on existence of a subject; and
managing the existence confirmation result in association with a non-fungible token,
the obtaining and managing being carried out by a management apparatus.

### (Supplementary Note SA1)

A generation method including:
obtaining reference information which is for confirmation on existence of a subject; and
generating, with reference to the reference information, an existence confirmation result, which is a result of confirmation on existence of the subject and which is to be associated with a non-fungible token,
the obtaining and generating being carried out by a generation apparatus.

### (Supplementary Note SB1)

An information processing method including:
executing a confirmation test which is for confirmation on existence of the subject; and
providing, to a generation apparatus, response information given by the subject in response to the confirmation test, the generation apparatus generating an existence confirmation result, which is a result of confirmation on existence of the subject and which is to be associated with a non-fungible token,
the executing and providing being carried out by a terminal apparatus.

### (Supplementary Note SD1)

An information processing method including:
obtaining specifying information which is for specifying non-fungible data including (i) information indicating an existence confirmation result, which is a result of confirmation on existence of a subject, and (ii) a non-fungible token associated with the information indicating the existence confirmation result; and
managing the non-fungible data,
the obtaining and managing being carried out by an information processing apparatus.

### (Supplementary Note SF1)

An information processing method including:
obtaining specifying information which is for specifying a non-fungible token associated with an existence confirmation result, which is a result of confirmation on existence of a subject; and
executing an authentication process which refers to at least either of the existence confirmation result and the non-fungible token,
the obtaining and executing being carried out by an information processing apparatus.

### (Supplementary Note PC1)

A program for causing a computer to function as a management apparatus,
the program causing the computer to execute:
obtaining an existence confirmation result, which is a result of confirmation on existence of a subject; and
managing the existence confirmation result in association with a non-fungible token.

### (Supplementary Note PA1)

A program for causing a computer to function as a generation apparatus,
the program causing the computer to execute:
obtaining reference information which is for confirmation on existence of a subject; and
generating, with reference to the reference information, an existence confirmation result, which is a result of confirmation on existence of the subject and which is to be associated with a non-fungible token.

### (Supplementary Note PB1)

A program for causing a computer to function as a terminal apparatus,
the program causing the computer to execute:
executing a confirmation test which is for confirmation on existence of the subject; and
providing, to a generation apparatus, response information given by the subject in response to the confirmation test, the generation apparatus generating an existence confirmation result, which is a result of confirmation on existence of the subject and which is to be associated with a non-fungible token,

### (Supplementary Note PD1)

A program for causing a computer to function as a terminal apparatus,
the program causing the computer to execute:
obtaining specifying information which is for specifying non-fungible data including (i) information indicating an existence confirmation result, which is a result of confirmation on existence of a subject, and (ii) a non-fungible token associated with the information indicating the existence confirmation result; and
managing the non-fungible data.

### (Supplementary Note PF1)

A program for causing a computer to function as an information processing apparatus,
the program causing the computer to execute:
obtaining specifying information which is for specifying a non-fungible token associated with an existence confirmation result, which is a result of confirmation on existence of a subject; and
executing an authentication process which refers to at least either of the existence confirmation result and the non-fungible token.

### [Supplementary Remarks 3]

Some or all of the foregoing example embodiments can also be expressed as below.

### (Supplementary Note CC1)

A management apparatus including at least one processor, the at least one processor executing:
an obtaining process of obtaining an existence confirmation result, which is a result of confirmation on existence of a subject; and
a management process of managing the existence confirmation result in association with a non-fungible token.

### (Supplementary Note AA1)

A generation apparatus including at least one processor, the at least one processor executing:
an obtaining process of obtaining reference information which is for confirmation on existence of a subject; and
a generation process of generating, with reference to the reference information, an existence confirmation result, which is a result of confirmation on existence of the subject and which is to be associated with a non-fungible token.

### (Supplementary Note BB1)

A terminal apparatus including at least one processor, the at least one processor executing:
an execution process of executing a confirmation test which is for confirmation on existence of the subject; and
a providing process of providing, to a generation apparatus, response information given by the subject in response to the confirmation test, the generation apparatus generating an existence confirmation result which is a result of confirmation on existence of the subject and which is to be associated with a non-fungible token.

### (Supplementary Note DD1)

An information processing apparatus including at least one processor, the at least one processor executing:
an obtaining process of obtaining specifying information which is for specifying non-fungible data including (i) information indicating an existence confirmation result, which is a result of confirmation on existence of a subject, and (ii) a non-fungible token associated with the information indicating the existence confirmation result; and
a management process of managing the non-fungible data.

### (Supplementary Note FF1)

An information processing apparatus including at least one processor, the at least one processor executing:
an obtaining process of obtaining specifying information which is for specifying a non-fungible token associated with an existence confirmation result, which is a result of confirmation on existence of a subject; and
an authentication process of executing an authentication process which refers to at least either of the existence confirmation result and the non-fungible token.

### (Supplementary Note PPC1)

A non-transitory storage medium in which a program is stored, the program causing a computer to function as a management apparatus,
the program causing the computer to execute:
obtaining an existence confirmation result, which is a result of confirmation on existence of a subject; and
managing the existence confirmation result in association with a non-fungible token.

### (Supplementary Note PPA1)

A non-transitory storage medium in which a program is stored, the program causing a computer to function as a generation apparatus,
the program causing the computer to execute:
obtaining reference information which is for confirmation on existence of a subject; and
generating, with reference to the reference information, an existence confirmation result, which is a result of confirmation on existence of the subject and which is to be associated with a non-fungible token.

### (Supplementary Note PPB1)

A non-transitory storage medium in which a program is stored, the program causing a computer to function as a terminal apparatus,
the program causing the computer to execute:
executing a confirmation test which is for confirmation on existence of the subject; and
providing, to a generation apparatus, response information given by the subject in response to the confirmation test, the generation apparatus generating an existence confirmation result, which is a result of confirmation on existence of the subject and which is to be associated with a non-fungible token.

### (Supplementary Note PPD1)

A non-transitory storage medium in which a program is stored, the program causing a computer to function as a terminal apparatus,
the program causing the computer to execute:
obtaining specifying information which is for specifying non-fungible data including (i) information indicating an existence confirmation result, which is a result of confirmation on existence of a subject, and (ii) a non-fungible token associated with the information indicating the existence confirmation result; and
managing the non-fungible data.

### (Supplementary Note PPF1)

A non-transitory storage medium in which a program is stored, the program causing a computer to function as an information processing apparatus,
the program causing the computer to execute:
obtaining specifying information which is for specifying a non-fungible token associated with an existence confirmation result, which is a result of confirmation on existence of a subject; and
executing an authentication process which refers to at least either of the existence confirmation result and the non-fungible token,

Note that the above-described apparatus and system may further include a memory. In the memory, a program causing the processor to execute the obtaining process and the deriving process may be stored. The program may can be stored in a non-transitory, tangible storage medium capable of being read by a computer.

### REFERENCE SIGNS LIST

1: authentication system
A1: generation apparatus
A11: obtaining section
A12: generation section
B1: terminal apparatus
B11: execution section
B12: providing section
C1: management apparatus
C11: obtaining section
C12: management section
D1: information processing apparatus
D11: obtaining section
D12: management section
F1: information processing apparatus
F11: obtaining section
F12: authentication section
G1: distributed ledger system

What is claimed is:

1. A management apparatus comprising at least one processor, the at least one processor executing:
an obtaining process of obtaining an existence confirmation result, which is a result of confirmation on existence of a subject; and
a management process of managing the existence confirmation result in association with a non-fungible token.

2. The management apparatus according to claim 1, wherein:
the management process includes an issuing process of issuing the non-fungible token.

3. The management apparatus according to claim 1, wherein:
the obtaining process obtains time information associated with the existence confirmation result; and
the management process manages the existence confirmation result in association with the time information.

4. The management apparatus according to claim 1, wherein:
the obtaining process obtains position information; and
the management process manages the existence confirmation result in association with the position information.

5. The management apparatus according to claim 1, wherein:
the existence confirmation result includes a score relating to the confirmation on the existence.

6. The management apparatus according to claim 1, wherein:
the obtaining process obtains an existence-confirmation-result-for-updating; and
the management process updates, with use of the existence-confirmation-result-for-updating, the existence confirmation result associated with the non-fungible token.

7. The management apparatus according to claim 1, wherein:
the management process generates display data which is for the non-fungible token and which includes a display object corresponding to the existence confirmation result.

8. The management apparatus according to claim 1, wherein:
the non-fungible token is a token set to be non-transferable.

9. An information processing apparatus comprising at least one processor, the at least one processor executing:
an obtaining process of obtaining specifying information which is for specifying a non-fungible token associated with an existence confirmation result, which is a result of confirmation on existence of a subject; and
an authentication process which refers to at least either of the existence confirmation result and the non-fungible token.

10. The information processing apparatus according to claim 9, wherein:
the obtaining process further obtains time information associated with the existence confirmation result; and
the authentication process further refers to the time information.

11. The information processing apparatus according to claim 9, wherein:
the obtaining process further obtains position information associated with the existence confirmation result; and
the authentication process further refers to the position information.

12. The information processing apparatus according to claim 9, wherein:
the existence confirmation result includes a score relating to the confirmation on the existence; and
the authentication process further refers to the score.

13. The information processing apparatus according to claim 9, wherein:
the at least one processor further executes a providing process of providing a service to the subject in accordance with a result of the authentication process.

14. The information processing apparatus according to claim 9, wherein:
the at least one processor optimizes a condition of the authentication process on a basis of a machine learning model that has learned a relation between the existence confirmation result of the subject and a label.

15. A management method comprising:
obtaining an existence confirmation result, which is a result of confirmation on existence of a subject; and
managing the existence confirmation result in association with a non-fungible token,
the obtaining and managing being carried out by a management apparatus.

16. A non-transitory storage medium in which a program is stored,
the program causing a computer to function as a management apparatus recited in claim 1,
the program causing the computer to execute:
the obtaining process and the management process.
